(19) United States
(12) Patent Application Publication
(10) Pub. No.: US 2024/0157497 A1
(43) Pub. Date: May 16, 2024

(54) METHOD AND DEVICE FOR MACHINING A SHAFT OF AN APPARATUS AT A BEARING POINT OF THE SHAFT

(71) Applicant: Hubert HENNEBÖHL, Rüthen (DE)

(72) Inventor: Hubert HENNEBÖHL, Rüthen (DE)

(21) Appl. No.: 18/282,886

(22) PCT Filed: Feb. 14, 2022
(86) PCT No.: PCT/EP2022/053515

§ 371 Date: Sep. 19, 2023

(30) Foreign Application Priority Data
Mar. 26, 2021 (EP) 21165300.1

(51) Int. Cl. B24B 5/04; B23P 6/00; B24B 41/06

(52) U.S. Cl. CPC B24B 5/04; B23P 6/007; B24B 41/06

(57) ABSTRACT

The method and the device are used for processing a shaft of an apparatus which supports the shaft in rotation. The device is provided with a drive unit which can be attached to the apparatus and has a drive element that can be driven in rotation by a motor and is suitable for coupling to an end of the shaft to be machined. The device also has a holding unit, which can likewise be attached to the apparatus, for at least one of the following units:
a supporting bearing unit for supporting the shaft 464 to be machined;
a material removal unit for removing material from the shaft to be machined at its bearing point;
a material application unit for applying material to the shaft to be machined at its bearing point; and
a grinding unit for grinding down the material applied to the bearing point of the shaft to be machined.

The supporting bearing unit, the material removal unit, the material application unit and the grinding unit are operable during rotation of the shaft to be machined by means of the drive unit.

The invention relates to a method and a device for machining a shaft of an apparatus at a bearing point at which the shaft is rotatably supported in a bearing of the apparatus, which bearing is to be replaced.

The repair of shaft bearing damages of apparatuses may sometimes be rather complex and costly, in particular in the case of shafts rotating at comparatively high speeds. On the one hand, this is due to the fact that the apparatus or the installation to which the apparatus belongs is shut down for the time of repair, and that, on the other hand, disassembling the apparatus from the installation can be time-consuming and labor-intensive. Both is true, for example, for bearing damages of the generators of wind turbines. Both the disassembly and the assembly of such a generator from and into the nacelle require comparatively great effort, not least because of the lowering of the defective generator from the nacelle and the pulling of the generators up into the nacelle after repair.

Therefore, repair methods are already implemented with which it is attempted to repair the bearing damage of a generator of a wind turbine in the nacelle. For this purpose, the defective shaft bearing arrangement is disassembled and the defective bearing point of the shaft is machined by means of material removing units and material application units to be rotated around the shaft either automatically or manually, as well as by means of a grinding unit. This approach is not optimal, since the devices required to machine the shaft must be moved around the shaft in a complex manner, the shaft, which is stationary after disassembly of the bearing, no longer being movable. This causes deviations of the devices from their respective optimal machining position.

A device for machining a shaft of a machine is known from US-B-6 244 143, with which material can be removed from a shaft by means of a tool. In doing so, the shaft rotates, while being supported in its bearings.

GB-A-2 262 900 discloses a shaft machining device with a toll rotatable around a stationary shaft. Here, the shaft remains in its bearings.

US-A-2015/0135534 discloses a method for the posterior mounting of a rotor load sensor system on a main saft of a wind turbine supported in its bearing.

Finally, EP-A-3 112 678 discloses another method for machining a main shaft of a wind turbine supported in its bearing.

It is an object of the invention to provide an improved device and an improved method for machining a shaft of an apparatus at a bearing point at which the shaft is rotatably supported in a bearing of the apparatus, which bearing is to be replaced.

To achieve the object, the invention proposes a device for machining a shaft of an apparatus at a bearing point at which the shaft is rotatably supported in a bearing of the apparatus, which bearing is to be replaced, the device being provided with
a drive unit which can be attached to the apparatus and has a drive element that can be driven in rotation by a motor and is suitable for coupling to an end of the shaft to be machined,
a holding unit for a support bearing unit for supporting the shaft to be machined when the shaft is rotated with the bearing of the apparatus removed, the holding unit being adapted to be mounted to the apparatus,
the holding unit for holding the support bearing unit is provided together with at least one or more or all of the following units:
   a material removal unit for removing material from the shaft to be machined at its bearing point,
a material application unit for applying material onto the shaft to be machined at its bearing point, and
a grinding unit for grinding down the material applied onto the bearing point of the shaft to be machined,
the support bearing unit, the material removal unit, the material application unit and the grinding unit being operable with the shaft to be machined being rotated by the drive unit.

According to the invention, it is analogously provided to rotate the shaft while the shaft bearing arrangement is in a dismantled state, in order to machine the shaft while it rotates. For this purpose, the device according to the invention comprises a motor drive unit with a rotationally drivable drive element for a rotationally effective coupling with the shaft to be machined. Depending on the type of apparatus of which the shaft is to be machined, it is possible, if both ends of the shaft protrude beyond the apparatus, to arrange the drive unit on the end of the shaft the shaft bearing arrangement of which remains assembled. For this purpose, the drive unit advantageously comprises a frame which is fixedly connected to the apparatus and on which the motor of the drive unit and the drive element are arranged.

According to the invention, a holding unit is mounted to the apparatus on the side of the apparatus where the bearing to be replaced is located, to which holding unit the various devices are then mounted in order to machine the bearing point of the shaft. Among other things, according to the invention, the holding unit can be mounted with a support bearing unit which comprises at least one bearing block to support the shaft to be machined when the shaft bearing arrangement is in the disassembled state and to thus hold it in a position, in which the shaft to be machined can be rotated if it is arranged in the unit (e.g. the generator). Thus, the support bearing unit is an auxiliary bearing unit, as it were.

With the shaft bearing arrangement disassembled, a free space exists between the bearing point of the shaft and the housing of the apparatus which is used, according to the invention, to move the machining components of a material removal unit, a material application unit and a grinding unit into the same. The material removal unit is used, for example, to remove material chips from the bearing point of the shaft in order to “clean” the defective bearing point, as it were, and prepare it for the application of new material. This new material is applied using a material application unit, which may be a welding unit, for example. Thereafter, the excessive applied material is ground using a grinding unit, and the bearing point is thus finished, so that the new shaft bearing arrangement can be mounted.

Throughout the machining of the shaft, the same can be rotated, according to the invention, so that, different from prior art, the tools and components provided for the machining no longer have to be moved relative to and around the stationary, not rotating shaft; rather, these tools and components can be stationary with respect to the shaft, since the shaft is rotated.

The invention is applicable wherever bearing damages of an apparatus with a comparatively fast rotating shaft have to be repaired, namely at the operation site of the apparatus which therefore no longer has to be transported to a specific location for a replacement of a defective shaft bearing arrangement having a defective bearing point of the shaft. In this respect, the invention can be implemented in particular (but not exclusively) in wind turbines and in particular also in offshore wind turbines, on ships, in general electric machines (electric motors or generators), in gearings and in compressors, as well as turbines.

In the method of the invention for machining a shaft of an apparatus to be machined at a bearing point at which the shaft is rotatably supported in a bearing of the apparatus to be replaced wherein, with the shaft bearing arrangement being dismounted,
the shaft is held in its operating position by means of a support bearing unit,
the shaft is caused to rotate by means of a drive unit mounted on the apparatus,
using a material removal unit, material is removed at the bearing point of the shaft to be machined while the same is rotated,
using a material application unit, material is applied onto the bearing point of the shaft to be machined, and
using a grinding unit, the shaft to be machined is ground and/or polished at the bearing point.

To implement the method according to the invention, the shaft bearing arrangement to be replaced is first disassembled before machining the shaft. Because of the disassembly of the shaft bearing arrangement, the holding unit can be mounted on the side of the housing of the apparatus (e.g. the generator). Besides the actual bearing, shaft bearing arrangements of the type in question typically also have a so-called bearing plate mounted on the apparatus housing from outside (i.e. screwed to the housing). Instead of the bearing plate, the holding unit can now be mounted to the apparatus housing, which unit is, in the simplest case, a disc or plate which can be of a multi-part design, respectively. The various components and units required for machining the shaft in the manner provided by the invention can then be mounted on the holding unit. After the repair of the shaft, the units and components provided by the invention for this machining are dismounted so that the bearing plate with a new shaft bearing arrangement can be mounted.

As already described above, a feed unit can be mounted on the holding unit, the feed unit comprising a tool slide which is adjustable in the direction of the extension of the shaft to be machined, as well as radially to the same, on which the material removal unit, the material application unit and the grinding unit can be selectively mounted.

For a variable positioning of the individual units on the holding unit, it is advantageous if the holding unit has a plurality of receptions for the support bearing unit and/or the material removal unit and/or the material application unit and/or the grinding unit and/or for the drive unit.

A suitable material removal unit is, for example, a unit for machining the shaft by removing chips by means of a plane or a milling tool, or a material erosion unit.

The material application unit may be, for example, an electric welding unit, an arc welding unit, an inert gas welding unit or a laser welding unit, or a flame spraying unit.

The grinding unit can comprise a rotationally drivable grinding and/or polishing tool.

It is suitable if the support bearing unit comprises a bearing block (e.g. in the form of a steady rest) and/or if the support bearing unit includes a lubricant and/or if the support bearing unit comprises a lubricant supply means.

Moreover, it advantageous if the bearing support unit has a guide unit to radially guide and adjust as well as fix the at least one bearing block, the guide unit being mountable to the holding unit.

The drive unit suitably comprises an electric motor and an output gear wheel adapted to be connected in a torque-proof manner with the shaft to be machined, and an input gear wheel, in particular in the form of a cone gear wheel, arranged orthogonally thereto and adapted to be driven by the electric motor, which together form a (e.g. reduction) gear or are a part of a gearing of the drive unit. Due to the interposition of the gearing formed by the two gear wheels oriented orthogonally to each other, the structural height of the drive unit in the direction of the extension of the shaft is only small, so that this drive unit can also be installed on the apparatus when there is little space available.

The invention is described in more detail below by means of an exemplary embodiment and with reference to the drawing, in which In the Figures:

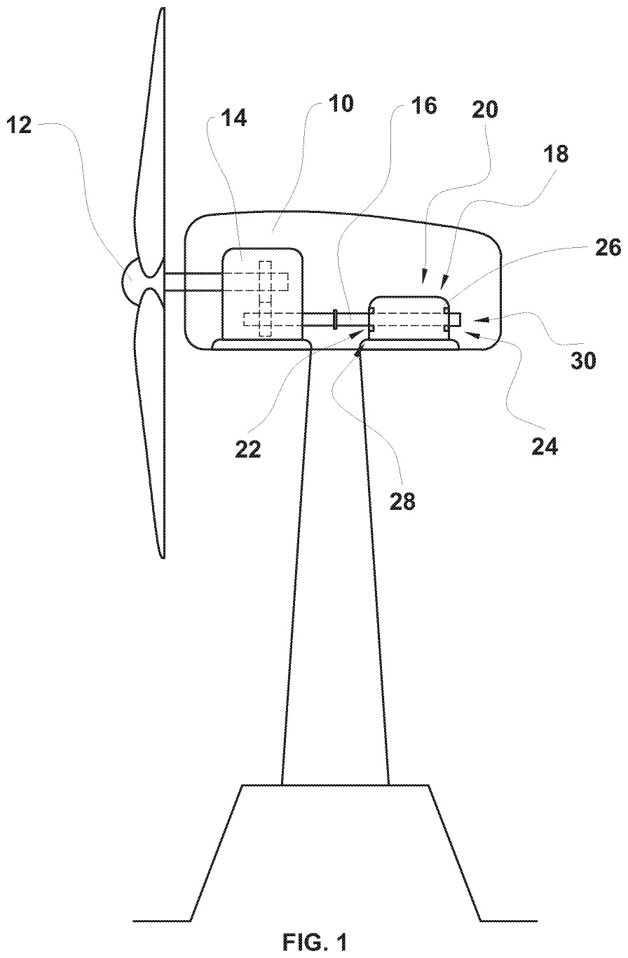

FIG. 1 is a heavily schematized side view of the drive train in the nacelle of a wind turbine for the generator thereof,

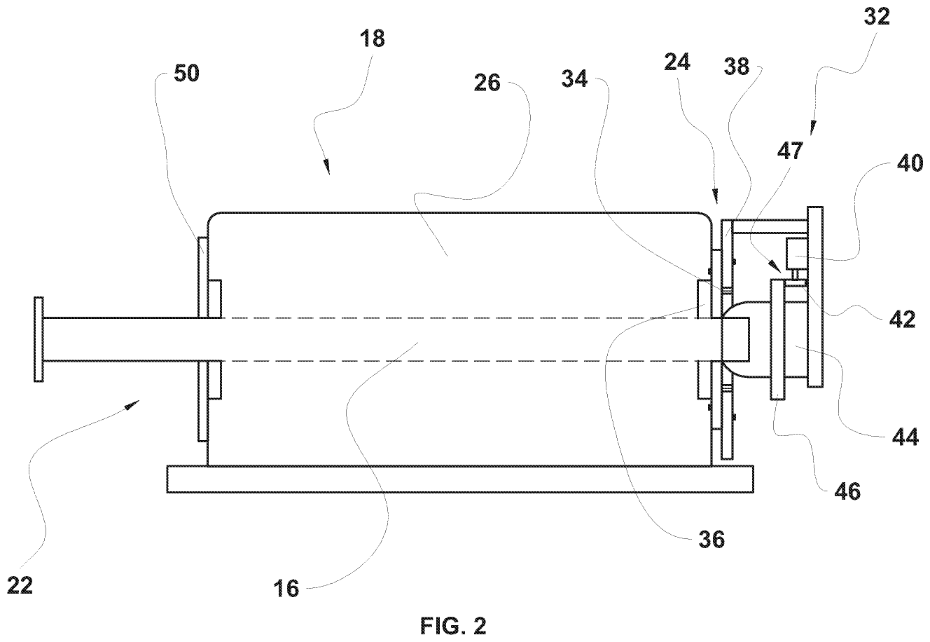

FIG. 2 schematically shows the structure of the drive unit for the rotating drive of the generator shaft to be machined during the machining thereof,

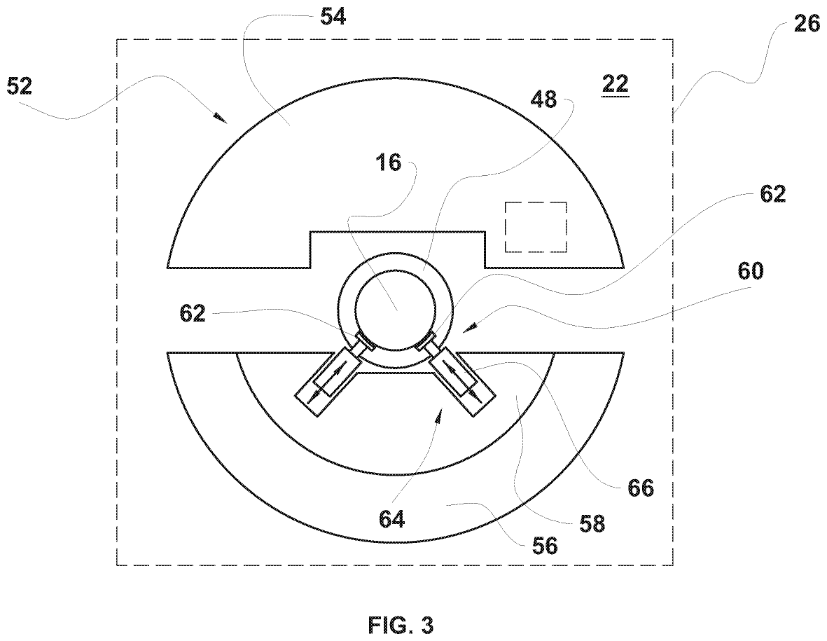

FIG. 3 is a top plan view on the end face of the generator housing with the shaft bearing arrangement removed to illustrate the function of the support bearing unit, and

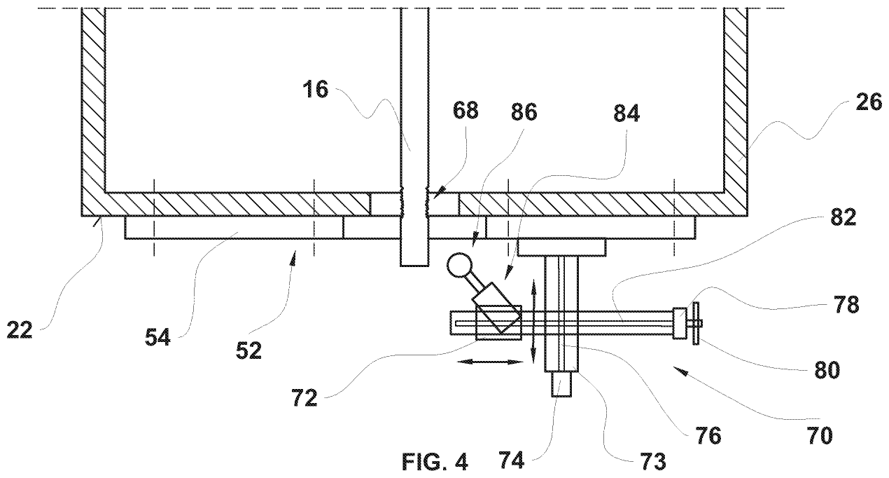

FIGS. 4 to 6 schematically show the situations in which the various tools and components for machining the bearing point of the shaft are arranged on a feed unit which itself is arranged on a holding unit attached to the housing.

As one of a number of applications for the implementation of the invention, FIG. 1 schematically shows a nacelle 10 of a wind turbine, the rotor 12 of which drives the shaft 16 of a generator 18 through a gearing 14. The generator 18 thus is an example for an apparatus 20 with a shaft 16 rotating relatively fast. In this embodiment, the shaft 16 is supported at both end faces 22, 24 of the housing 26 of the generator 18, for which purpose the generator 18 has a shaft bearing arrangement 28, 30 at the respective end faces.

FIG. 2 shows the assembly of a drive unit 32 on the end face 24 of the generator 18. A so-called bearing plate 34, at which the actual bearing 36 of the shaft arrangement 28 is located, is provided on the generator housing 26. A frame 38 of the drive unit 32 is mounted on this bearing plate 34, the drive unit comprising an electric motor 40 with a cone gear wheel 42 rotated by the electric motor 40. An output gear 46 is located on a coupling element 44 of the drive unit 32, which gear rotates the coupling element 44. The coupling element 44 is connected to the end of the shaft 16 in a clamping manner, for example, and thus in a torque-proof manner In this context, a form-fitting connection or the like would also be conceivable. The two gear wheels 42, 46 form a gearing 47.

It is now possible to rotate the shaft 16 bx means of the drive unit 32 while the shaft is machined.

The situation during the machining of the shaft 16 on the other end face 22 of the generator housing 26 is shown in FIGS. 3 to 6. In the top plan view on this end face 22 in FIG. 3, the shaft 16 can be seen which is arranged in a hole 48 in which the already disassembled bearing 36 was located before. The space previously occupied by the bearing plate 50 (see FIG. 2) is used to mount a holding unit 52, which in this embodiment is a multi-part holding unit, which can comprise a plurality of mounting plates 54, 56, 58, each in the shape of a partial disk. However, a one-piece mounting plate can also be used.

As can be seen in particular in FIG. 3, the shaft 16 is supported by a support bearing unit 60 and is held in such a position that it is possible to rotate the haft 16 despite the shaft bearing arrangement 28 being removed. The support bearing unit 60 has two bearing blocks 62 in the form of, for example, steady rests, which are provided with lubricant and are radially displaceable and adjustable in different radial positions. For this purpose, the support bearing unit 60 has a guide unit 64 provided with two guide elements 66 which are arranged in a displaceable manner on the mounting plate 58, for example (see also the double-headed arrows in FIG. 3).

FIGS. 4 to 6 show different situations during the machining of the shaft 16 for the repair of the damages at the bearing point 68 thereof. At its front end face 22, the housing 26 of the generator 18 is provided with the holding unit 52. The mounting plates 54, 56 and 58 used ion this case are provided with receptacles to retain various tools and units, as well as components required for the machining of the bearing point 68 of the shaft 16. Ideally, a feed unit 70 is mounted on the holding unit 52 for this purpose, which feed unit comprises a tool slide 72 which can be displaced by motor and/or manually in the direction of the extension of the shaft 16 as well as orthogonally thereto (the latter in at least one dimension). For this purpose, the feed unit 70 is provided with a guide bar 73 comprising, for example, a motor 74 and an adjustment spindle 76, by which a transversely extending guide bar 78 can be displaced, on which the tool slide 72 can be longitudinally displaced by operating a manual wheel 80 with a spindle 82, for example. According to FIG. 4, a material removal unit 84 is mounted on the tool slide 72, which comprises a milling tool 86 in the form of a rotationally drivable milling head. This milling head 86 is moved by the feed unit 70 until it arrives in the intermediate space between the shaft 16 and the housing 26 of the generator 18 in order to now remove material from the bearing point 68 of the shaft 16 and to thereby prepare the bearing point 68 for subsequent working steps.

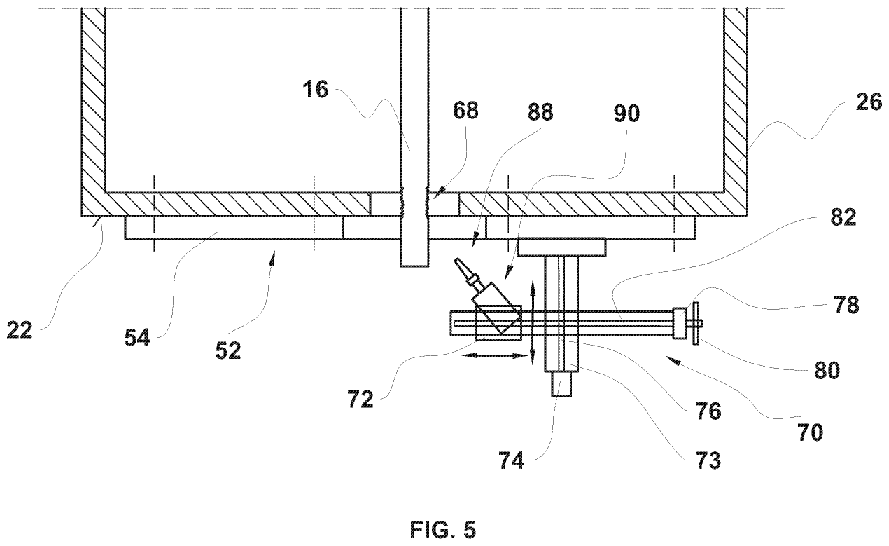

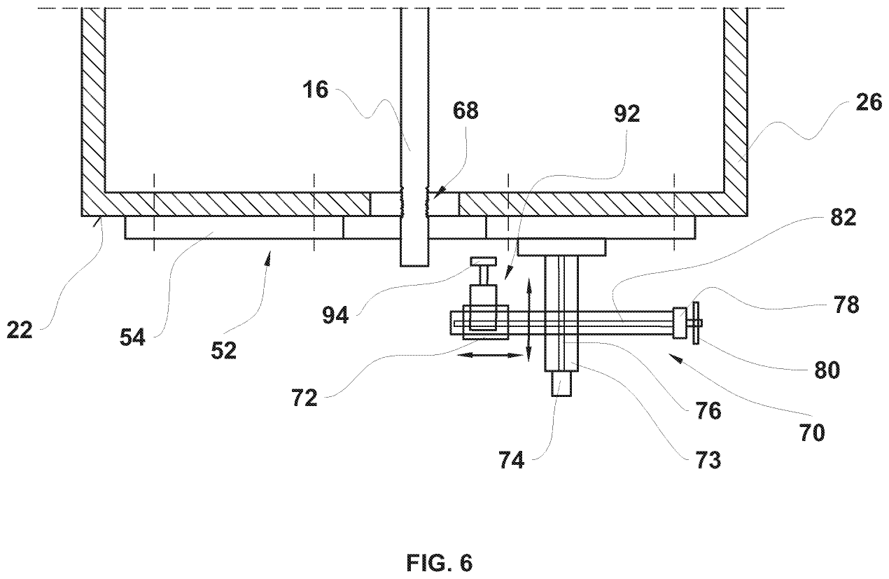

FIG. 5 shows the situation of FIG. 4, however, with a laser welding unit 88 being mounted on the tool slide 72 as a material application unit 90. This material application unit 90 can be used to apply material onto the (later) bearing point 68 of the shaft 16, which will then be worked with a grinding unit 92 with respect to the surface, as shown in FIG. 6, for example. The grinding unit 92 has a rotationally drivable grinding disc 94, the diameter of which is adapted to the size of the distance between the shaft 16 and the generator housing 26 at the end face 22 thereof.

After the shaft 16 has been machined as described above, the holding unit 52 is removed from the end face 22 of the generator housing 26 so that the new shaft bearing arrangement 30 with the associated bearing plate 50 can be mounted on the end face 22.

The invention has been described above with reference to the replacement of a bearing and the machining of the shaft of a generator. However, the invention is also useful in repairing or replacing the bearing of the main or rotor shaft of a wind turbine. In this case, the holding unit for the (auxiliary) support bearing unit and for the assembly of the shaft machining units is configured as a unit supported in the nacelle of the wind turbine (e.g. as a block or a frame), on which unit the support bearing unit with its auxiliary bearings (e.g. bearing blocks with steady rests) is located. The main shaft is driven by an auxiliary motor, for example, which drives e.g. the output shaft of the gearing leading to the generator, for which purpose the generator should be separated from the gearing, but does not necessarily have to be separated therefrom. With wind turbines having no gearing, the auxiliary motor would have to act upon the main shaft, which would also be possible with wind turbines having a transmission (namely after separation of the drive train between the main shaft and the generator).

### LIST OF REFERENCE NUMERALS

10 nacelle
12 rotor
14 transmission
16 shaft
18 generator
20 apparatus
22 end face
24 end face
26 generator housing
28 shaft bearing arrangement at the end face
30 shaft bearing arrangement at the end face
32 drive unit
34 bearing plate
36 bearing
38 frame
40 electric motor
42 cone gear wheel
44 coupling element
46 output gear wheel
47 transmission
48 hole
50 bearing plate
52 holding unit
54 partial disc-shaped mounting plates
56 partial disc-shaped mounting plates
58 partial disc-shaped mounting plates
60 support bearing unit
62 bearing block
64 guide unit
66 guide element
68 bearing point
70 feed unit
72 tool slide
73 guide bar
74 motor
76 adjustment spindle
78 guide bar
80 manual wheel
82 spindle
84 material removal unit
86 milling tool
88 laser welding unit
90 material application unit
92 grinding unit
94 grinding wheel

1. A device for machining a shaft of an apparatus at a bearing point at which the shaft is rotatably supported in a bearing of the apparatus to be replaced, comprising
a drive unit which can be attached to the apparatus and has a drive element that can be driven in rotation by a motor and is suitable for coupling to an end of the shaft to be machined,
a holding unit for a support bearing unit for supporting the shaft to be machined when the shaft is rotated with the bearing of the apparatus removed, the holding unit being adapted to be mounted to the apparatus,
the holding unit for holding the support bearing unit is provided together with at least one or more or all of the following units:
a material removal unit for removing material from the shaft to be machined at its bearing point,
a material application unit for applying material to the shaft to be machined at its bearing point; and
a grinding unit for grinding down the material applied to the bearing point of the shaft to be machined,
the supporting bearing unit, the material removal unit, the material application unit and the grinding unit being operable during rotation of the shaft to be machined by means of the drive unit.

2. The device according to claim 1, characterized in that a feed unit can be mounted on the holding unit, the feed unit comprising a tool slide which is adjustable in the direction of the extension of the shaft to be machined, as well as radially to the same, on which the material removal unit, the material application unit and the grinding unit can be selectively mounted.

3. The device according to claim 1, wherein the holding unit has a plurality of receptacles for a variable positioning of the support bearing unit and/or the material removal unit and/or the material application unit and/or the grinding unit of the drive unit.

4. The device according to claim 1, wherein the material removal unit is designed as a unit for machining the shaft by removing chips using a plane or a milling tool, or as a material erosion unit, in particular in the form of a spark erosion unit.

5. The device according to claim 1, wherein the material application unit is designed as an electric welding unit, an arc welding unit, an inert gas welding unit or a laser welding unit, or as a flame spraying unit.

6. The device according to claim 1, wherein the grinding unit comprises a rotationally drivable grinding and/or polishing tool.

7. The device according to claim 1, wherein the support bearing unit comprises at least one bearing block and/or the support bearing unit includes a lubricant and/or the support bearing unit comprises a lubricant supply means.

8. The device according to claim 1, wherein the support bearing unit comprises a guide unit to radially guide and adjust as well as fix the at least one bearing block, the guide unit being mountable to the holding unit.

9. The device according to claim 1, wherein the drive unit comprises an electric motor and an output gear wheel adapted to be connected in a torque-proof manner with the shaft to be machined, and an input gear wheel, in particular in the form of a cone gear wheel, arranged orthogonally to the output gear wheel and adapted to be driven by the electric motor.

10. A method for machining a shaft of an apparatus to be machined at a bearing point at which the shaft is rotatably supported in a bearing of the apparatus to be replaced, wherein, with the shaft bearing arrangement being dismounted, according to the method,
the shaft is held in its operating position by means of a support bearing unit,
the shaft is caused to rotate by means of a drive unit mounted on the apparatus,
using a material removal unit, material is removed at the bearing point of the shaft to be machined while the same is rotated,
using a material application unit, material is applied onto the bearing point of the shaft to be machined, and
using a grinding unit, the shaft to be machined is ground and/or polished at the bearing point.

11. The method according to claim 10, wherein after the machining of the shaft, the drive unit, the material removal unit, the material application unit, the grinding unit and the support bearing unit are removed and the apparatus is provided with a new shaft bearing.

12. The method according to claim 10, wherein the shaft bearing to be replaced is disassembled prior to the machining of the shaft.
